(19) United States
(12) Patent Application Publication
(10) Pub. No.: US 2012/0221352 A1
(43) Pub. Date: Aug. 30, 2012

(54) PROCESS FOR CREATING A CARE PLAN

(75) Inventor: Michael Georgeff, Melbourne (AU)

(73) Assignee: Precedence Health Care PTY Limited, Victoria (AU)

(21) Appl. No.: 13/505,315

(22) PCT Filed: Oct. 29, 2010
(86) PCT No.: PCT/AU10/01445

§ 371 Date: May 1, 2012

(30) Foreign Application Priority Data
Nov. 2, 2009 (AU) 2009905339

(51) Int. Cl. G06Q 50/22

(52) U.S. Cl. 705/2

(57) ABSTRACT

A process for creating a care plan comprising the steps of: a) receiving personal data in a computer system, such data identifying: i) personal characteristics of a human subject; and ii) conditions for which the human subject requires treatment; b) the computer system subjecting the personal data to software triggering rules which, based on the content of the personal data, allocates the personal data to a plurality of software base rule sets wherein each base rule set has rules for treating a respective condition; c) the computer system subjecting the personal data to the allocated base rule sets to generate a base care plan for each condition, wherein each base care plan has data representative of action steps for treating the respective condition; d) the computer system subjecting each base care plan to software comparison rules to identify conflicts between the base care plans; and e) the computer system subjecting conflicts between the base care plans to software resolution rules to resolve at least some conflicts and to generate a resolved care plan.

### FIELD OF INVENTION

This invention relates to the creation of care plans for humans, preferably although not necessarily, in the context of health care.

### BACKGROUND

It is known to create care plans for human patients in need of health care. Some patients suffer from a number of medical conditions and are provided with separate care plans for each condition. In some cases the separate care plans conflict with one another or do not, as a combination, serve the best interests of the patient. It is accordingly an object of a preferred form of the present invention to go some way towards addressing this problem, or to at least provide the public with a useful choice.

### SUMMARY OF THE INVENTION

According to one aspect of the invention there is provided a process for creating a care plan comprising the steps of:
a) receiving personal data in a computer system, such data identifying:
   i) personal characteristics of a human subject (eg name, age, sex, weight, etc); and
   ii) a condition for which the human subject requires treatment (eg medical conditions);
b) the computer system subjecting the personal data to software triggering rules which, based on the content of the personal data, allocates the personal data to a software base rule set wherein the base rule set has rules for treating the condition;
c) the computer system subjecting the personal data to the allocated base rule set to generate a base care plan for the condition, wherein the base care plan has data representative of action steps for treating the condition;
d) the computer system subjecting the base care plan to software comparison rules to identify conflicts between the base care plan and a second care plan for a different condition for which the human subject requires treatment;
e) the computer system subjecting conflicts between the care plans to software resolution rules to resolve at least some conflicts and to generate a resolved care plan.

Optionally the second care plan has not been generated by the computer system:
a) at all (eg it may have been generated manually or by a different computer system); or
b) at the same time as the base care plan (eg by the computer system in the same manner as the base care plan).

Optionally the second care plan has been generated by the same computer system, by a different computer system, or manually, but is in each case compatible with software rules utilised by the first mentioned computer system.

Optionally the process is such that the personal data at step a) identifies more than one condition for which the human subject requires treatment, at step b) the triggering rules which, based on the content of the personal data, allocate the personal data to a plurality of software base rule sets wherein each base rule set has rules for treating a respective condition, at step c) the computer system subjects the personal data to the allocated base rule sets to generate a base care plan for each condition, wherein each base care plan has data representative of action steps for treating the respective condition, at step d) the computer system subjects each base care plan to software comparison rules to identify conflicts between the base care plans, and at step e) the computer system subjects conflicts between the base care plans to the software resolution rules to resolve at least some conflicts and to generate the resolved care plan.

Optionally if the resolution rules are unable to resolve a conflict then such conflict is tagged as unresolved in the resolved care plan.

Optionally after the resolution rules have been applied to a conflict the computer system amends the corresponding base care plan and then again subjects the base care plans to the comparison rules to identify new conflicts and, if any such conflicts are found, the system subjects them to the resolution rules prior to generating the resolved care plan.

Optionally the process incorporates a facility for manual modification of base care plans and/or resolved care plans.

Optionally if a further human subject only requires treatment for one condition then the triggering rules allocate the personal data to one base rule set for generating a single base care plan, the resolution rules are bi-passed, and the resolved care plan is generated to be at least substantially the same as the base care plan.

Optionally the conditions comprise medical conditions.

Optionally the computer system comprises one or more computers.

Optionally at least some rules of the/each base rule set have a priority weighting which is interpreted by the resolution rules and used for resolving at least some conflicts.

### BRIEF DESCRIPTION OF THE DRAWING

Some preferred embodiments of the invention will now be described by way of example and with reference to the accompanying drawing, of which:

FIG. 1 is schematic illustration of a computer system for generating health care plans.

### DETAILED DESCRIPTION OF PREFERRED EMBODIMENTS

In a preferred embodiment of the invention a computer system 1 is used to generate a health care plan for a human patient suffering from a plurality of chronic diseases, for example any combination of diabetes, heart disease, stroke, asthma, arthritis and depression.

Personal data 2 for the patient is loaded into the system 1. The personal data may represent any relevant details, for example the name, age, sex, weight and contact address of the patient. It also includes the medical conditions suffered by the patient. In some cases the medical conditions may be represented by symptoms suffered by the patient.

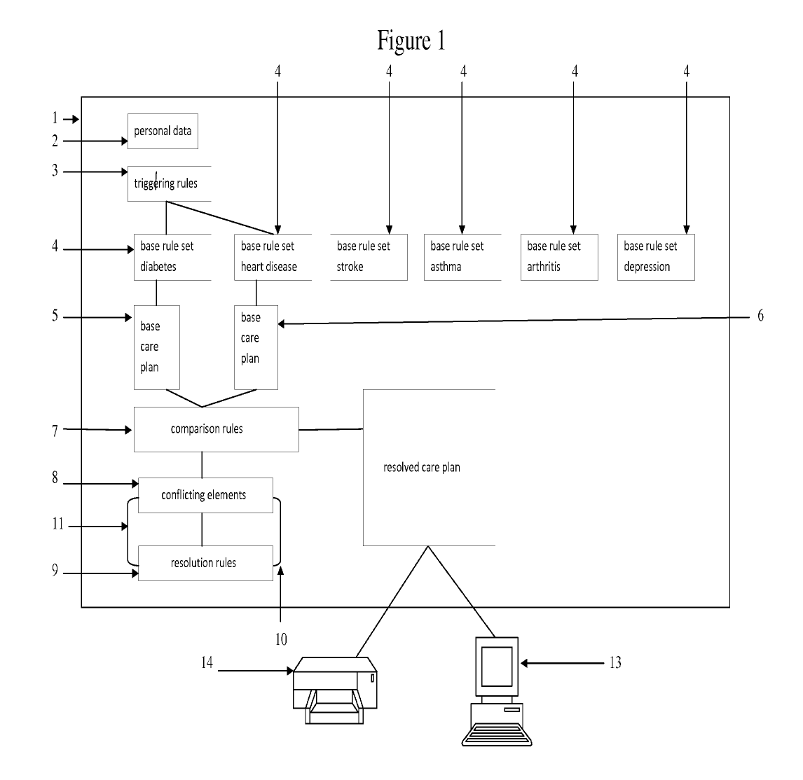

The personal data 2 is processed by software triggering rules 3. Based on the content of the personal data, the triggering rules allocate the personal data to an appropriate number of software base rule sets 4. Each base rule set 4 provides rules for treating a particular medical condition. As indicated in FIG. 1, in this case the triggering rules have determined that the patient suffers from diabetes and heart disease, and has allocated the personal data to the two base rule sets applicable to only those diseases.

The system processes the personal data according to the base rule sets for diabetes and heart disease and generates a base care plan for each disease. The diabetes base care plan is indicated at 5 and the heart disease base care plan is indicated at 6. These base care plans 5, 6 comprise data representative of action steps or goals deemed appropriate for treating the respective disease. The action steps may for example involve taking certain medications at certain doses and at certain times, attending therapy sessions, attending appointments with physicians, doing certain amounts of exercise, consuming certain foods or drinks, refraining from smoking, losing a certain amount of body weight, reducing blood pressure by a certain amount, etc, etc.

In some situations the base care plans 5, 6 may have conflicting elements, for example between them they may specify contra indicated medicines, conflicting blood pressure or weight loss goals, conflicting amounts of exercise, double booked appointments with health care professionals, etc. In order to address this the computer system subjects the base care plans 5, 6 to software comparison rules 7.

The comparison rules 7 identify conflicting elements 8 between the base care plans 5, 6 and subjects these to software resolution rules 9. For example if the conflicting elements 8 include contra indicated medicines then the resolution rules may provide that one of the medicines be substituted by a specific different medicine. If for example the conflicting elements include differing blood pressure goals then the resolution rules may determine that the lower blood pressure goal override the higher goal, etc.

The resolution rules 9 have the effect of modifying one or other of the base care plans 5, 6. As indicated at 10 and 11, the modified base care plans are again subjected to the comparison rules 7 in case the modifications have created new conflicting elements. If there are any, then the resolution rules 9 are applied again and the process repeated until all conflicts that can be resolved by the resolution rules have been resolved. At that time the system 1 generates a resolved care plan 12. The resolved care plan 12 comprises a consolidated set of data representing action steps and goals deemed appropriate for treating the patient for diabetes and heart disease. In a sense the resolved care plan 12 is a composite of the base care plans, ie after they have had conflicts resolved. If there are any conflicts which the resolution rules were unable to resolve then these are flagged in the resolved care plan 12 so that they are able to be identified and resolved by a suitable health care professional.

In cases where the comparison rules determine that the same action step or goal is in more than one of the base care plans then the resolution rules may determine that only one instance of that step or goal be applied in the resolved care plan. The system has a facility for the resolved care plan 12 to be expressed in alpha numeric characters as a screen display 13 or a hard copy printout 14, etc.

In some embodiments of the invention the action steps and goals corresponding to the base care plans may each have a priority weighting which can be interpreted by the system 1. In the case of conflicts the resolution rules 9 use the weightings in determining how to resolve the conflicts. For example if two steps or goals conflict then the resolution rules may be set to select the step or goal with the higher priority weighting to override the other.

Optionally the system provides a facility for human operators to amend the personal data, the triggering rules, the base care plans, the comparison rules or the resolution rules, or any combination of these.

Optionally the computer system 1 comprises one or more computers. If there is more than one computer then they may be at the same or different geographical locations.

In some embodiments of the invention elements of the base care plans may be subjected to the comparison and resolution rules before a base care plan is settled. References indicating that the base care plans are subjected to such rules should thus be interpreted to cover situations where complete, incomplete or partial base care plans are so subjected.

In some embodiments of the invention the comparison rules may identify that elements from two different base care plans, while not inconsistent with one another, can be readily substituted by a third element. In such cases the resolution rules determine that the third element be entered into the resolved care plan rather than the first or second element. For the purpose of this document elements in base care plans which are able to be optimised by substitution in this way should be regarded as conflicting elements.

In some embodiments of the invention the computer system may receive data representative of a pre-prepared care plan and may subject this to the comparison and resolution rules as if it was one of the base care plans 5, 6.

While some preferred embodiments of the invention have been described by way of example it should be appreciated that modifications and improvements can occur without departing from the scope of the following claims.

1. A process for creating a care plan comprising the steps of:
a) receiving personal data in a computer system, such data identifying:
i) personal characteristics of a human subject; and
ii) a condition for which the human subject requires treatment;
b) the computer system subjecting the personal data to software triggering rules which, based on the content of the personal data, allocates the personal data to a software base rule set wherein the base rule set has rules for treating the condition;
c) the computer system subjecting the personal data to the allocated base rule set to generate a base care plan for the condition, wherein the base care plan has data representative of action steps for treating the condition;
d) the computer system subjecting the base care plan to software comparison rules to identify conflicts between the base care plan and a second care plan for a different condition for which the human subject requires treatment;
e) the computer system subjecting conflicts between the care plans to software resolution rules to resolve at least some conflicts and to generate a resolved care plan.

2. A process according to claim 1, wherein the second care plan which has not been generated by the computer system:
a) at all; or
b) at the same time as the base care plan.

3. A process according to claim 1, wherein the personal data at step a) identifies more than one condition for which the human subject requires treatment, wherein at step b) the triggering rules which, based on the content of the personal data, allocate the personal data to a plurality of software base rule sets wherein each base rule set has rules for treating a respective condition, wherein at step c) the computer system subjects the personal data to the allocated base rule sets to generate a base care plan for each condition, wherein each base care plan has data representative of action steps for treating the respective condition, wherein at step d) the computer system subjects each base care plan to software comparison rules to identify conflicts between the base care plans, and wherein at step e) the computer system subjects conflicts between the base care plans to the software resolution rules to resolve at least some conflicts and to generate the resolved care plan.

4. A process according to claim 1, wherein if the resolution rules are unable to resolve a conflict then such conflict is tagged as unresolved in the resolved care plan.

5. A process according to claim 3, wherein after the resolution rules have been applied to a conflict the computer system amends the corresponding base care plan and then again subjects the base care plans to the comparison rules to identify new conflicts and, if any such conflicts are found, the system subjects them to the resolution rules prior to generating the resolved care plan.

6. A process according to claim 1, incorporating a facility for manual modification of base care plans and/or resolved care plans.

7. A process according to claim 1, wherein if a further human subject only requires treatment for one condition then the triggering rules allocate the personal data to one base rule set for generating a single base care plan, the resolution rules are bi-passed, and the resolved care plan is generated to be at least substantially the same as the base care plan.

8. A process according to claim 1, wherein the conditions comprise medical conditions.

9. A process according to claim 1, wherein the computer system comprises more than one computer.

10. A process according to claim 1, wherein at least some rules of the/each base rule set have a priority weighting which is interpreted by the resolution rules and used for resolving at least some conflicts.

11. (canceled)

12. A process according to claim 2, wherein if the resolution rules are unable to resolve a conflict then such conflict is tagged as unresolved in the resolved care plan.

13. A process according to claim 3, wherein if the resolution rules are unable to resolve a conflict then such conflict is tagged as unresolved in the resolved care plan.

14. A process according to claim 4, wherein after the resolution rules have been applied to a conflict the computer system amends the corresponding base care plan and then again subjects the base care plans to the comparison rules to identify new conflicts and, if any such conflicts are found, the system subjects them to the resolution rules prior to generating the resolved care plan.

15. A process according to claim 3, wherein at least some rules of the/each base rule set have a priority weighting which is interpreted by the resolution rules and used for resolving at least some conflicts.
